(19) United States
(12) Patent Application Publication
(10) Pub. No.: US 2005/0160944 A1
(43) Pub. Date: Jul. 28, 2005

(54) Permafrost ceramicrete

(75) Inventors: Arun S. Wagh, Naperville, IL (US); Brandon Fisher, Bolingbrook, IL (US); Ramkumar Natarajan, Chicago, IL (US)

Correspondence Address: Harry M. Levy, Esq.;Emrich & Dithmar, LLC, Suite 2080, 125 South Wacker Drive, Chicago, IL, 60606, US

(73) Assignee: The University of Chicago, Chicago, IL (US)

(21) Appl. No.: 10/941,592

(22) Filed: Sep. 14, 2004

Related U.S. Application Data
(60) Provisional application No. 60/538,818, filed on Jan. 23, 2004.

(51) Int. Cl. C04B 12/02

(52) U.S. Cl. 106/691; 106/705; 106/814; 106/802

(57) ABSTRACT

A dry mix of a calcined oxide of Ca and/or Mg and an acid phosphate and fly ash with or without insulating extenders useful in permafrost conditions. Calcined oxide is present at about 12% to about 40% by weight and the acid phosphate is present at about 35% to about 45% by weight. The fly ash is present at about 10% to about 50% by weight with the fly ash being between about 50% to about 100% class F with the remainder class C. Insulating extenders are present in the range from 0% to about 15% by weight of the combined calcined oxide and acid phosphate and fly ash. 0.1% to about 0.5% boric acid and/or borate by weight of the dry mix is present.

### RELATED APPLICATIONS

This application, pursuant to 37 C.F.R. 1.78(c), claims priority based on provisional application U.S. Provisional Application Ser. No. 60/538,818 filed Jan. 23, 2004.

### CONTRACTUAL ORIGIN OF THE INVENTION

The United States Government has rights in this invention pursuant to Contract No. W-31-109-ENG-38 between the U.S. Department of Energy and The University of Chicago representing Argonne National Laboratory.

### BACKGROUND OF THE INVENTION

Conventional Portland cement concretes have difficulty in setting as well as performing suitably in freezing temperatures. This is because of several reasons.

1. The water in the cement may freeze even before the cement sets.

2. The water in the pores and capillaries of the cement may freeze and expand and crack the structure.

3. Mismatch of expansion coefficients of the cement and aggregates may produce flaws in the concrete during freeze thaw cycles.

4. If the cement is used to stabilize borehole casings in permafrost regions, it should be sufficiently insulating to ensure that the outside permafrost structure does not melt when hot oil and gas flows through. In particular, the top 2000 feet in permafrost region, like at North Slope oil fields in Alaska, is frozen and should not be disturbed during production of hot crude. Similarly, the pipeline support structures in permafrost regions are destabilized by melting of the permafrost ground due to heat conducted through the structure during the flow of hot crude through the pipeline.

5. The conventional building systems in cold climate use concrete that has thermal conductivity ≈_{—}1.3_W/m.K. For better energy efficiency, more insulating cements are needed.

6. Large-scale storage of cryogenic fluids such as liquid nitrogen needs containers (Dewars) made of insulating materials. The common dewars use steel tanks, which need to be transported to the site and welded in place. A locally available construction material is more desirable and has less design limitations. The common construction materials such as Portland or calcium aluminate cements cannot be used for this application because these cements do not have adequate low thermal conductivity, and in addition, because of pore fluids in them, they cannot sustain freeze-thaw cycles of loading unloading of the cold liquid. In addition, because conventional concrete does not exhibit sufficiently low thermal conductivity, the fluid may boil over inside and pressurize containers or simply escape through pressure valves or the high thermal conductivity requires prohibitively thick walls to lower thermal losses.

Our invention is an alternative phosphate based cement system that is rapid setting, strong and pore-free and a thermally insulating cement that can be good alternative permafrost cement.

Superior permafrost cement phosphate cement should exhibit the following properties.

It should be pore-free so that it does not trap pore fluids, because pore fluids freeze and expand and crack the matrix. Another way of stating this that there are few if any interconnected pores.

Very low thermal conductivity is necessary. If the product is used as an oil well cement so it does not thaw the formation and destabilize the casing. If one product is used as a support to pipeline for oil and gas transport, such an insulating cement will not destabilize the supports, and if it is used to construct large size dewars, it will insulate the cryogenic fluids from the surroundings and protect them from evaporating.

The product should have inherent superior mechanical properties if used for load-bearing applications such as supports for pipelines in permafrost region. Superior mechanical properties allow addition of second phase materials such as Styrofoam beads, extendospheres, high carbon ash etc. to lower the thermal conductivity further and still retain adequate load bearing strength.

The product should also be fast-setting cement so that if used in permafrost region, worker time in cold temperature is less and also the product will set fast and allow little time for the water to freeze.

The exothermic heat produced during setting of the cement should be as low as possible. This heat can melt the surrounding ice and create annular space between the cement and the surrounding environment. Water in this space will expand and contract in freeze-thaw cycles and destabilize the casing.

The product should exhibit good bonding properties with earth materials such as downhole rocks, and also with casing steel, and should also be self-bonding so those repair jobs are easier and less expensive.

In addition, if this cement is used for oil and gas well applications, it should satisfy American Petroleum Institute standards for drilling cements. These are: 1) the slurry should be a very low viscosity fluid, 2) should provide sufficient time (at least three hours for pumping before it sets, and 3) once placed, the water fraction from the slurry should not freeze and the slurry should set as rapidly as possible.

Once developed these cements may have other applications also. The cements used in construction of dwellings and industrial buildings do not have sufficiently low conductivity to insulate the buildings during heat transfer from inside of the building to outside environment in winter, and vice versa in summer. Polymer based insulating materials such as urea formaldehyde are used in such cases. These products are expensive, flammable, and also produce toxic fumes when they burn. Thus they are hazardous to dwellers, and to workers who produce and apply them. Thus there is a need for cements that are dense, non-flammable, exhibit good strength characteristics, can be applied in both room temperature and low temperature regimes and be insulating. Phosphate cement based compositions disclosed here fulfill this need.

### SUMMARY OF THE INVENTION

Accordingly, it is an object of the present invention to provide a dry mix of a calcined oxide of Ca and/or Mg and an acid phosphate and fly ash with or without insulating extenders, the calcined oxide being present in the range of from about 12% to about 15% by weight, the acid phosphate being present in the range of from about 37% to about 45% by weight, the fly ash being present in the range of from 40% to about 50% by weight, the fly ash being between about 50% to about 100% class F with the remainder class C, the insulating extenders being present in the range of from 0% to about 15% by weight of the combined calcined oxide and acid phosphate and fly ash, and from about 0.1% to about 0.5% boric acid and/or borate by weight of the dry mix as an additive.

Another object of the invention is to provide a structural member made from an aqueous slurry of a dry mix of a calcined oxide of Ca and/or Mg and an acid phosphate and fly ash with or without insulating extenders, the calcined oxide being present in the range of from about 12% to about 15% by weight, the acid phosphate being present in the range of from about 37% to about 45% by weight, the fly ash being present in the range of from 40% to about 50% by weight, the fly ash being between about 50% to about 100% class F with the remainder class C, the insulating extenders being present in the range of from 0% to about 15% by weight of the calcined oxide and acid phosphate and fly ash, and from about 0.1% to about 0.5% boric acid and/or borate by weight of the dry mix as an additive, wherein water is present in an amount of about 40% by weight of the dry mix forming the slurry until the slurry sets to form the structural member.

Yet another object of the present invention is to provide a dry mix of a calcined oxide of Ca and/or Mg and an acid phosphate and fly ash and a silicate of Ca and/or Mg with or without insulating extenders, the calcined oxide being present in the range of from about 12% to about 40% by weight, the acid phosphate being present in the range of from about 35% to about 40% by weight, the fly ash being present in the range of from 10% to about 25% by weight, the silicate being present in the range of from about 10% to about 25% by weight, the insulating extenders being present in the range of from 0% to about 15% by weight of said dry mix, and boric acid and/or borate being present in the range of from about 0.1% to about 0.5% by weight of the dry mix as an additive.

A final object of the present invention is to provide a structural member made from an aqueous slurry of a dry mix of a calcined oxide of Ca and/or Mg and an acid phosphate and fly ash and a silicate of Ca and/or Mg with or without insulating extenders, the calcined oxide being present in the range of from about 12% to about 40% by weight, the acid phosphate being present in the range of from about 35% to about 40% by weight, the fly ash being present in the range of from 10% to about 25% by weight, the silicate being present in the range of from about 10% to about 25% by weight, the insulating extenders being present in the range of from 0% to about 15% by weight of said dry mix, and boric acid and/or borate being present in the range of from about 0.1% to about 0.5% by weight of the dry mix as an additive, wherein water is present in an amount of from about 20% to about 40% by weight of said dry mixture forming a slurry capable of setting in less than 24 hours to form said structural member.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIGS. 1 and 2 are continuity graphs illustrating examples of the present invention.

### DESCRIPTION OF THE PREFERRED EMBODIMENT

This invention is based on Ceramicrete® product developed at Argonne National Laboratory. It is a mixture of magnesium oxide (MgO), monopotassium phosphate (KH₂PO₄), and water. To this, fly ash is added to provide superior mechanical properties and physical integrity. The reaction between the binder components may be represented by the following chemical equation.
MgO+KH₂PO₄+5H₂O=MgKPO₄.6H₂O (1)
Specific compositions of this binder, fly ash, and other insulating materials such as Styrofoam, saw dust, silica hollow spheres, high carbon ash, and any other polymeric or inorganic fillers with very low thermal conductivity provides a mixture that can be used as cement for the applications stated above. The preferred composition claimed in this invention provides a pumpable, nonflammable superior cement for permafrost oil field applications and as a general insulating cement, particularly useful for, but not limited to dewars in cold climates.

Table 1 contains the major properties of an embodiment of this phosphate cement. This cement has a particular composition of 50-wt. % Ceramicrete binder, 50 wt. % of a mixture of equal amount of Class C and F fly ashes and 0.5 wt. % boric acid. For the sake of comparison, properties of conventional portland-based cements in use are shown. A comparison of the two cements is made in the last column of the table.

TABLE 1
Comparison between invented and Portland cement

| | Cement | | |
|---|---|---|---|
| Property | Invented | Portland | Remarks |
| Density (g/cm³) | 1.87 | 2.4 | Invented cement is lighter |
| Slurry density (g/cm³) | 1.9 | | Slurry of invented cement is lighter and |
| | | | hence easier to pump. |
| Open porosity | 0.3 | ≈_5 | No pore fluids in invented cement and much |
| (vol. %) | | | more stable in freeze-dry cycles. |
| Gas permeability (milli | 0.004 | ≈_0.1 | Very low permeability of invented cement |
| darcies) | | | makes it an excellent sealant in oil wells by |
| | | | preventing gas migration. |
| Room temperature | 7000-8000 | ≈_4000 | High room temperature compressive |
| compressive strength (psi) | | | strength allows modification of the invented |
| | | | cement by addition of extendospheres, |
| | | | Styrofoam etc, and improves on thermal |
| | | | properties, weight of the slurry etc. It also |
| | | | allows addition of retardants to extend |
| | | | pumping time. |
| Thermal conductivity | 0.27 | 0.53 | Lower thermal conductivity makes the |
| (W/m · K) | | | invented cement a better insulating cement. |
| Heat of fusion per unit | 347 | 514-640 | Low heat of fusion ensures less thawing of |
| volume (J/cm³) | | | formation during setting. |
| Setting in hydrocarbon | Setting is | CO₂ carbonates | This is a very useful property for use of |
| environment | unaffected by | cement and | invented cement in gas hydrate region. Set |
| | CO₂ | flash sets it. | portland cement is also deteriorated by |
| | environment | | hydrocarbons while invented product is not. |

The inventive compositions may be taken as a base cement and modified to further improve its desirable properties by adding a range of insulating particles or to produce air-entrained product. Previous tests have shown that this base insulating cement has number of advantages over conventional cements used in oil industry. These include items 1-6 above, all of which are attained by the invention.

### EXAMPLE 1

### Limits on Composition of the Slurry

To determine limits on composition of the slurry, several compositions were attempted and the slurry was maintained in freezing environment (30° F.) to see if it sets. Table 2 provides these compositions, observations and inferences of the tests.

TABLE 2
Observations in the tests with various compositions of the
invented cement

| | | Boric | |
|---|---|---|---|
| Binder | Ash | acid | Observations |
| (wt. %) | (wt. %) | (wt. %) | and inferences |
| 40 | 60 | 0.5 | The water in the slurry froze and the cement |
| | | | did not set. It needs a minimum amount of |
| | | | KH₂PO₄ to lower the freezing point, which |
| | | | this composition did not have. |
| 50 | 50 | 0.5 | These cements set well in freezing |
| | | | environment. They had sufficient KH₂PO₄ to |
| 60 | 40 | 0.5 | lower the freezing point below 30° F. |
| | | | Viscosity was too high and consistency was |
| 50 | 50 | 0 | more than 30 Bc. This means at least |
| | | | 0.5 wt. % boric acid is needed to lubricate |
| | | | particles. |

These examples indicate that a minimum of 50 wt. % must be the binder in the blend of the cement and an addition of at least 0.5 wt. % of boric acid is needed to make it pumpable. Borax (sodium borate) is also acceptable.

### EXAMPLE 2

### Pumpability of the Cement

To demonstrate the pumpability of the invented cement, thickness-time test was conducted using a consistometer and American Petroleum Standards (Spec. 10) procedure.

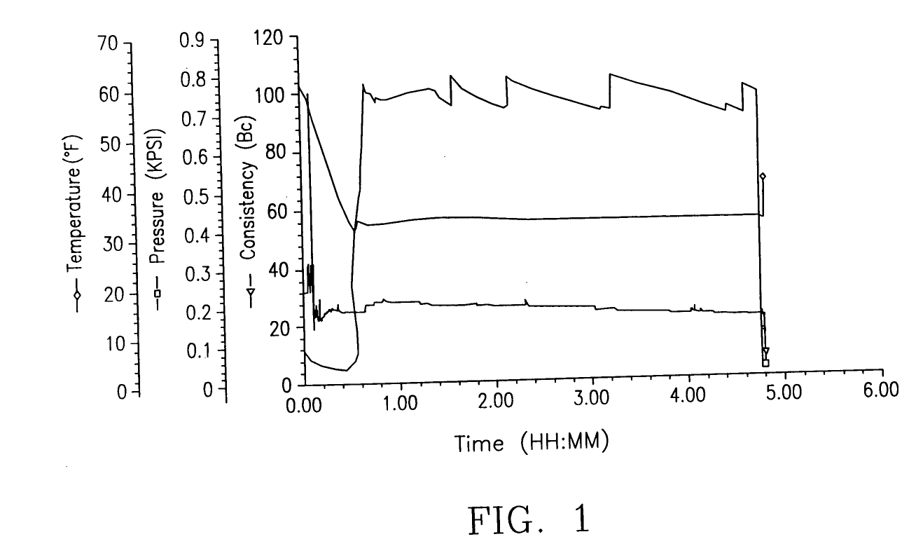

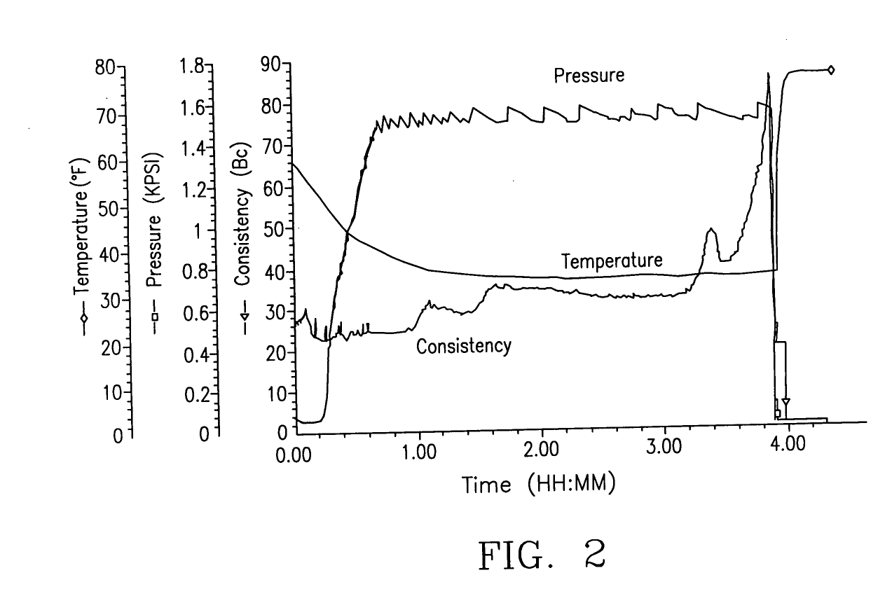

The cement with the composition given in the second row in table 2 was tested at 40° F. and 30° F. and at a pressure of 700 psi. In both cases, the pumping viscosity of the slurry was 13 Bearden units (Bc) throughout. A viscosity of up to 30 Bc is acceptable for pumping and the results of this test showed that the viscosity is very low and hence this cement will pump very well in permafrost region. Without boric acid, the viscosity was too high. FIG. 1 shows the time and thickness graph in the test at 30° F. The pumping time for this cement was more than five hours. This is an important aspect of this cement that it does not set when being mixed or pumped and only hardens when placed. Thus, there is no danger of flash-setting and clogging the pipes will be encountered with this cement.

### EXAMPLE 3

### Durability of the Inventive Cement in Freeze Thaw Cycles in Liquid Nitrogen

Using the composition given in second row of Table 2, cubes of the cements of ASTM standard specifications (2×2×2 in³) were made. They were cured for one week and then immersed in liquid nitrogen, left there for 15 minutes and removed. The one made only with Class C fly ash showed cracks and fell apart eventually under cryogenic fracture tests. The one made with class F ash showed some surface cracks initially, but those these cracks healed. It was dipped ≈15 times and taken out but it showed no loss of any integrity. In another test, a small cup of 10 cms wall thickness and ≈100 ml volume was made with the same composition. Liquid nitrogen was poured in it and even after several minutes, one could hold the cup in bare hands without feeling the frost on hand. This demonstrated that the composition with only Class F is not only durable, but also a good insulating dewar for storage of cryogenic fluids.

### EXAMPLE 4

### Incorporating Extendospheres

As an example of a light weight insulating cement, we attempted several compositions with extendospheres. The extendospheres were provided by PQ Corporation and labeled as Q-CEL 6042. These were silica spheres separated from fly ash. In each case we had 50 wt. % invented phosphate cement and 0.5 wt. % boric acid. The content of ashes and extendospheres is given in Table 3 along with the observations and inferences. These examples showed that one can add 10-15 wt. % extendospheres in the invented cement. Theoretical models predict that for a cement with x % concentration of the spheres the thermal conductivity drops by a factor (1−x)^{y} where y is between 2 and 3. This means the cement with its already low thermal conductivity will exhibit a thermal conductivity of 0.2-0.22 W/m.K when 10 wt. % extendospheres are added to it, and 0.17-0.19 W/m.K when 15 wt. % extendospheres are added to it. These are some of the lowest values of thermal conductivity for any cement.

TABLE 3
Compositions of light-weight insulating cement

| Composition (wt. %) | | | |
|---|---|---|---|
| C/F ash | Extendo- | Water (% of | Observations |
| each | sphere | total powder) | and inferences |
| 45 | 10 | 40 | The product set well. Pumping time |
| | | | measured by using consistometer |
| | | | was >3 hours. |
| 42.5 | 15 | 40 | The product set marginally well. |
| 40 | 20 | 40 | The product did not set. Even mixing |
| | | | was a problem because of the cement |
| | | | slurry was too light and would move |
| | | | with the paddle in the consistometer. |

This product has a great value in regions such as Alaska and northern Canada where oil and natural gas exploration and production is a major industry. It is also a very important cement for use in manufacture of large size dewars for storage of cryogenic fluids. Even in the construction industry, this invention can provide range of insulating materials both in cold and tropical regions.

The above outlined material is particularly suited for dewars and the like, but a bore hole material should set more rapidly than the several days required by the materials disclosed above.

MgO 12-40 wt. %, KH₂PO₄ 35-40 wt. %, Class C ash 10-25 wt. %, calcium silicate 10-25 wt. %, and water 20-40 wt.% of the dry powder mixture, and boric acid 0.2-0.5 wt.% of the powder. This is preferred range.

### EXAMPLE 5

We mixed 280 g of MgO, 300 g of KH₂PO₄, 110 g of C-ash, 110 g of calcium silicate, 1 g of boric acid and 300 ml of water. This was mixed and then tested in the consistometer. It gave a pumping time of 4 hours. When cured at 23 degrees F., it set within 10 hours. The compressive strength was 1200 psi.

While particular embodiments of the present invention have been shown and described, it will be appreciated by those skilled in the art that changes and modifications may be made without departing from the invention in its broader aspects.

Therefore, the aim in the appended claims is to cover all such changes and modifications as fall within the true spirit and scope of the invention. The matter set forth in the foregoing description and accompanying drawings is offered by way of illustration only and not as a limitation. The actual scope of the invention is intended to be defined in the following claims when viewed in their proper perspective based on the prior art.

1. A dry mix of a calcined oxide of Ca and/or Mg and an acid phosphate and fly ash with or without insulating extenders, said calcined oxide being present in the range of from about 12% to about 15% by weight, said acid phosphate being present in the range of from about 37% to about 45% by weight, said fly ash being present in the range of from 40% to about 50% by weight, said fly ash being between about 50% to about 100% class F with the remainder class C, said insulating extenders being present in the range of from 0% to about 15% by weight of the combined calcined oxide and acid phosphate and fly ash, and from about 0.1% to about 0.5% boric acid and/or borate by weight of the dry mix as an additive.

2. The dry mix of claim 1, wherein the calcined oxide is MgO and the acid phosphate is KH₂PO₄.

3. The dry mix of claim 1, wherein fly ash is present at about 50% by weight and in substantially equal amounts of class C and F.

4. The dry mix of claim 1, wherein class C fly ash is present up to about 25% by weight.

5. The dry mix of claim 1, wherein the insulating extenders are one or more of silica particles or styrofoam or insulating polymer or carbon.

6. The dry mix of claim 1, and further including up to about 2% by weight fibers.

7. The dry mix of claim 1, wherein said calcined oxide is MgO and said class F fly ash is present in the range of from about 20% to about 50% by weight with the remainder of the fly ash being class C and further including water in the amount of about 40% by weight of the dry mix forming a slurry.

8. The slurry of claim 7, wherein MgO is present not less than 12.5% and said acid phosphate is KH₂PO₄ present not less than 37.5%.

9. A structural member made from an aqueous slurry of a dry mix of a calcined oxide of Ca and/or Mg and an acid phosphate and fly ash with or without insulating extenders, said calcined oxide being present in the range of from about 12% to about 15% by weight, said acid phosphate being present in the range of from about 37% to about 45% by weight, said fly ash being present in the range of from 40% to about 50% by weight, said fly ash being between about 50% to about 100% class F with the remainder class C, said insulating extenders being present in the range of from 0% to about 15% by weight of the calcined oxide and acid phosphate and fly ash, and from about 0.1% to about 0.5% boric acid and/or borate by weight of said dry mix as an additive, wherein water is present in an amount of about 40% by weight of the dry mix forming the slurry until the slurry sets to form the structural member.

10. The structural member of claim 9, wherein the calcined oxide is MgO.

11. The structural member of claim 9, wherein fly ash is present at about 50% by weight and in substantially equal amounts of class C and F.

12. The structural member of claim, wherein class C fly ash is present up to about 25% by weight.

13. The structural member of claim 9, wherein the insulating extenders are one or more of silica particles or styrofoam or insulating polymer or carbon.

14. The structural member of claim 9, and further including up to about 2% by weight fibers.

15. The structural member of claim 9, wherein said calcined oxide is MgO and said class F fly ash is present in the range of from about 20% to about 50% by weight with the remainder of the fly ash being class C.

16. The structural member of claim 15, wherein MgO is present not less than 12.5% and said acid phosphate is KH₂PO₄ present not less than 37.5%.

17. A dry mix of a calcined oxide of Ca and/or Mg and an acid phosphate and fly ash and a silicate of Ca and/or Mg with or without insulating extenders, said calcined oxide being present in the range of from about 12% to about 40% by weight, said acid phosphate being present in the range of from about 35% to about 40% by weight, said fly ash being present in the range of from 10% to about 25% by weight, said silicate being present in the range of from about 10% to about 25% by weight, said insulating extenders being present in the range of from 0% to about 15% by weight of said dry mix, and boric acid and/or borate being present in the range of from about 0.1% to about 0.5% by weight of the dry mix as an additive.

18. The dry mix of claim 17, wherein said calcined oxide is substantially all MgO.

19. The dry mix of claim 18, wherein said acid phosphate is KH₂PO₄.

20. The dry mix of claim 19, wherein said MgO and said KH₂PO₄ are each present in an amount of not less than 30% by weight.

21. The dry mix of claim 18, wherein said fly ash is class C.

22. The dry mix of claim 20, wherein said silicate is Ca silicate.

23. The dry mix of claim 22, and further including water present in the amount of from about 35% to about 40% by weight of said dry mix to form a slurry.

24. A structural member made from an aqueous slurry of a dry mix of a calcined oxide of Ca and/or Mg and an acid phosphate and fly ash and a silicate of Ca and/or Mg with or without insulating extenders, said calcined oxide being present in the range of from about 12% to about 40% by weight, said acid phosphate being present in the range of from about 35% to about 40% by weight, said fly ash being present in the range of from 10% to about 25% by weight, said silicate being present in the range of from about 10% to about 25% by weight, said insulating extenders being present in the range of from 0% to about 15% by weight of said dry mix, and boric acid and/or borate being present in the range of from about 0.1% to about 0.5% by weight of the dry mix as an additive, wherein water is present in an amount of from about 20% to about 40% by weight of said dry mixture forming a slurry capable of setting in less than 24 hours to form said structural member.

25. The structural member of claim 24, wherein said calcined oxide is substantially all MgO.

26. The structural member of claim 25, wherein said acid phosphate is KH₂PO₄.

27. The structural member of claim 26, wherein said MgO and said KH₂PO₄ are each present in an amount of not less than 30% by weight.

28. The structural member of claim 27, wherein said fly ash is class C.

29. The structural member of claim 28, wherein said silicate is Ca silicate.

30. The structural member of claim 29, wherein water is present in the range of from about 35% to about 40% by weight of said dry mix to form the slurry.
